(19) United States
(12) Patent Application Publication
(10) Pub. No.: US 2008/0223414 A1
(43) Pub. Date: Sep. 18, 2008

(54) Compositions and methods for removing titanium dioxide from surfaces

(75) Inventor: Timothy J. Schuett, Crown Point, IN (US)

Correspondence Address: STOUT, UXA, BUYAN & MULLINS LLP, 4 VENTURE, SUITE 300, IRVINE, CA, 92618, US

(73) Assignee: Dober Chemical Corporation, Midlothian, IL (US)

(21) Appl. No.: 11/717,898

(22) Filed: Mar. 13, 2007

(51) Int. Cl. C11D 3/02; B08B 3/00

(52) U.S. Cl. 134/34; 134/42; 510/108

(57) ABSTRACT

Compositions for removing titanium dioxide-containing materials located on a surface of a piece of process equipment generally include an aqueous carrier and a polycarboxylic acid component in an amount effective to provide the composition with an acidic pH in a range of between about 4.0 to about 5.0. The compositions are effective to provide enhanced removal of titanium dioxide containing materials from a surface when the surface are contacted with the compositions when the compositions are at relatively low temperatures.

### BACKGROUND OF THE INVENTION

This invention generally relates to removing titanium dioxide from surfaces and more specifically relates to compositions and methods for removing titanium dioxide-containing materials from surfaces, for example, of surfaces of processing equipment.

Titanium dioxide is a very useful additive. It provides, for example, whiteness, opacity and protection in paints, foods, pharmaceuticals, cosmetics and various other products. Process equipment, such as vessels, coaters, piping and the like, is used to incorporate titanium dioxide into various products.

Over a period of time, such processing equipment becomes heavily coated with such titanium dioxide-containing material. Periodically, this process equipment must be cleaned in order to perform effectively. In particular, the titanium dioxide-containing material must be removed from the surfaces of the equipment in order that the equipment can perform its function effectively and efficiently. In addition, because the equipment is often used in the pharmaceutical and/or food industries, the cleaning operation itself must be effective to remove all of the titanium dioxide-containing material, and must be acceptable to, for example, the U.S. Food and Drug Administration, for use in the pharmaceutical and/or food industries. Such cleaning operations must also be cost effective.

Prior titanium dioxide removal operations have involved the use of alkaline cleaners. However, such cleaners have been unable to completely remove the titanium dioxide from the surfaces of the process equipment. This is particularly disadvantageous since the cleaning operations, particularly in the food and pharmaceutical industry, are subject to sophisticated validation procedures to insure that the equipment is sufficiently clean. In order to achieve this degree of cleanliness, costly measures have had to be implemented. Because titanium dioxide is a widely used white pigment, many processes that involve coloring objects or fibers will result in contaminated machinery, containers, and filters. In addition, titanium dioxide scale frequently forms on titanium metal during processes used to produce objects made of the metal.

Equipment used in the manufacturing process of polyester fabric becomes contaminated with titanium dioxide. Titanium dioxide is used in the manufacture of polyester fiber primarily as a colorant and opacifier, and secondarily to prevent certain unwanted properties inherent in raw polyester fabric. During the polyester manufacturing process, liquid polyester is filtered through a media, contaminating the media with organic compounds and titanium dioxide. The filter media is typically a fine stainless steel wire mesh nickel-brazed onto a base. During cleaning, the filter is subjected to a fluidized bath containing hot aluminum oxide particles to remove organic compounds. Titanium dioxide, aluminum oxide and residual organic compounds contaminate these filters after the initial cleaning.

Pharmaceutical tablets are coated with compositions containing various binders, pigments and other additives. Residues from the coating compositions, particularly those containing titanium dioxide pigments, are very difficult or impossible to remove from the processing equipment in which the coating procedure is performed without resorting to manual methods which are difficult and very time consuming. Ultra-sonic devices can be used for facilitating removal of these residues but these devices are not suitable for large equipment.

Some conventional methods for removing titanium dioxide and residual organic compounds require immersing the contaminated workpiece in hot, concentrated alkaline solution. However, when sodium hydroxide reacts with titanium dioxide, sodium hydrogen titanate is formed, which is a gelatinous substance that is virtually impossible to remove by mechanical techniques. It is the removal of this intractable substance that requires rigorous manual work to remove. Ng, U.S. Pat. No. 3,690,949, the entire disclosure of which is incorporated herein by this reference, teaches removal of titanium dioxide scale from titanium metal workpieces using a highly alkaline cleaner containing sodium gluconate and corrosion inhibitors at 200 to 300° F. (93° C. to 148° C.). In Alexander et al, U.S. Pat. No. 2,790,738, the entire disclosure of which is incorporated herein by this reference, a method is disclosed that requires immersing a contaminated workpiece in molten alkali metal hydroxide, heated to approximately 700° F. (about 371° C.).

Chao, U.S. Pat. No. 4,292,090, the entire disclosure of which is incorporated herein by this reference, describes a method for removing titanium dioxide from a filter element by immersing a contaminated filter element in an alkaline solution made from a concentrated aqueous alkaline hydroxide solution and a calcium salt or from a basic calcium salt, for example, calcium oxide.

Dobrez et al., U.S. Pat. No. 5,763,377, the entire disclosure of which is incorporated herein by this reference, discloses compositions and methods that have been found to be effective in removing titanium dioxide from surfaces.

There remains a need for compositions and methods for more effectively, efficiently and safely removing titanium dioxide-containing materials from surfaces of process equipment.

### SUMMARY OF THE INVENTION

New compositions and methods useful for removing a titanium dioxide-containing material located on a surface, for example, the surface of process equipment, have been discovered. The present compositions and methods provide a very useful, safe and effective system for removing such titanium dioxide-containing materials. For example, it has been found that the use of selected materials, as described herein, in relatively low, cost effective concentrations in an aqueous medium, are effective to substantially completely remove titanium dioxide-containing materials from surfaces, for example, but not limited to, stainless steel surfaces. The compositions and methods can be used for cleaning process equipment without requiring removal or dismantling of the equipment. In other words, the compositions and methods can be safely used in clean-in-place procedures. The degree of removal provided by the compositions and methods of the present invention preferably is sufficiently high so that the criteria set by analytical validation procedures used to determine equipment cleanliness are met with few or no further steps or cleaning procedures.

In a broad aspect of the present invention, compositions are provided for removing a titanium dioxide-containing material located on a surface, for example, a non-titanium surface, for example, an interior or exterior surface of a piece of process equipment.

The compositions generally comprise an aqueous carrier and an acid component in an amount effective to provide the composition with an acidic pH of greater than about 4.0. The compositions are effective to provide enhanced removal of titanium dioxide from a surface when the composition is contacted with the surface at a temperature of less than about 50° C. relative to when the composition is contacted with an identical surface at a temperature of 80° C.

The acid component generally comprises a polycarboxylic acid component, for example, a polycarboxylic acid component selected from the group consisting of citric acid and tartaric acid. In some embodiments, the acid component consists essentially of the polycarboxylic acid component. In a preferred embodiment, the polycarboxylic acid component is present in the composition in an amount in a range of about 1% to about 5% by weight of the composition.

In some embodiments, the composition comprises an acid component in an amount effective to provide the composition with a an acidic pH of greater than about 4.0, wherein the acid component comprises a polycarboxylic acid and the composition has enhanced titanium dioxide removal effectiveness at a given set of conditions including a temperature of less than about 50° C. relative to an identical composition including hydroxyl acetic acid in place of the polycarboxylic acid at identical conditions.

In other aspects of the invention, the composition may further comprise a chelating agent other than said polycarboxylic acid. The composition may further comprise an effective amount of a hydrotrope component. Preferably, the hydrotrope component has an acidic nature, for example, the hydrotrope component is an aromatic phosphate ester. The composition may further comprise a chelating agent, for example a chelating agent other than citric acid. For example, the chelating agent is an ethylenediaminetetraacetic acid (“EDTA”) component.

In addition, the composition preferably comprises an effective amount of a plurality of different dispersant agents and/or an effective amount of a plurality of different surfactant agents.

In another broad aspect of the invention, methods are provided for removing a titanium dioxide-containing material located on a non-titanium surface. The methods generally comprise the steps of contacting said titanium dioxide-containing material located on said surface with a composition comprising an aqueous carrier and an acid component in an amount effective to provide the composition with a an acidic pH of greater than about 4.0. The acid component comprises a polycarboxylic acid component. The composition is effective to provide enhanced removal of titanium dioxide from the surface when the composition is contacted with the surface at a temperature of less than about 50° C. relative to when the composition is contacted with an identical surface at a temperature of 80° C.

### DETAILED DESCRIPTION

The present compositions and methods have been found to very effectively remove titanium dioxide-containing materials from processing equipment surfaces, preferably sufficiently so as to meet the criteria of rigorous equipment cleanliness validation procedures, for example, such as those set forth by the U.S. Food and Drug Administration, for the food and pharmaceutical industries.

These and other aspects and advantages of the present invention will become apparent in the following detailed description and claims.

### DETAILED DESCRIPTION OF THE INVENTION

Titanium dioxide is useful, for example, in coatings, in food products, medications and the like materials for human and animal consumption. In making such products, the process equipment used often becomes heavily coated with the titanium dioxide-containing materials. As part of the routine cleaning operation, a piece of equipment in question is taken out of service and processed to remove the titanium dioxide-containing material located on surfaces, for example, interior surfaces, of the equipment.

The present invention provides compositions and methods effective to remove such titanium dioxide-containing materials from surfaces of process equipment.

The titanium dioxide-containing materials removed in accordance with the present invention may be titanium dioxide itself, or a combination or mixture of components including titanium dioxide. For example, the titanium-dioxide containing materials removed with the compositions and methods of the invention include materials containing both titanium dioxide and iron oxide. Titanium dioxide may be applied or added to a medication or food product together with one or more other components useful to provide an independent benefit or benefits to the product and/or to facilitate the application of titanium dioxide to the product. Examples of such other components include binders, plasticizers, colorants, lubricants, fillers and the like. Such other components include those conventionally used with titanium dioxide in the production of products, such as those described herein.

Although the titanium dioxide may be present as a mixture with one or more other components, the titanium dioxide itself is believed to be particularly difficult to remove from process equipment surfaces because of its extremely small particle size and often leaves a white residue on such surfaces that is very difficult or even impossible to remove by mechanical or conventional chemical means.

The present invention has as a primary object the removal, preferably the substantially complete removal, that is the removal of at least about 90%, more preferably at least about 95% and still more preferably at least about 99% to about 100%, of a titanium dioxide-containing material located on a surface.

In some particularly advantageous embodiments, the compositions are most effective in removing titanium dioxide-containing materials when the compositions are within a temperature range from about 25° C. to about 45° C. when applied to the materials. Advantageously, materials that are removed from surfaces using the compositions and methods of the present invention include those materials containing both titanium dioxide and iron-oxide, for example, materials containing titanium dioxide and iron-oxide in an organic matrix.

In a broad aspect of the invention, methods are provided for removing a titanium-dioxide containing material located on a surface. The methods comprise the steps of contacting said titanium-dioxide containing material located on said surface with a composition comprising a polycarboxylic acid component in an amount effective to reduce adhesion between said titanium dioxide-containing material from said surface during the contacting. Advantageously, the step of contacting is performed with the composition at a temperature of less than about 50° C. In some embodiments, the composition is at a temperature of less than about 40° C., for example is less than about 30° C. during the step of contacting. More preferably, the composition is used at the coolest temperature that can be achieved without the composition falling below the cloud point of the composition during the step of contacting.

Advantageously, the composition is effective to provide enhanced removal of the titanium dioxide-containing material from a surface when the material located on the surface is contacted with the composition at a temperature of less than about 50° C. relative to when an identical material located on an identical surface is contacted with the composition at a temperature of 70° C.

In some embodiments, the step of contacting comprises immersing the surface having the titanium dioxide-containing material located thereon in the composition. In other embodiments, the step of contacting comprises directing a spray of the composition at the titanium dioxide-containing material located on the surface.

In another broad aspect of the invention, compositions are provided for removing titanium dioxide-containing materials located on a surface, including materials containing both titanium dioxide and iron oxide. The compositions generally comprise an aqueous carrier, for example, water, and an acid component in an amount effective to provide the composition with an acidic pH of greater than about 4.0. The compositions contain at least about 20% by weight, preferably at least about 50% by weight, of water, for example, city or tap water, preferably such water which has been softened (that is, treated to reduce hardness). The acid component comprises a polycarboxylic acid component. In accordance with the invention, the compositions have enhanced titanium dioxide removal effectiveness at a given set of conditions, including a temperature of less than about 50° C., relative to an identical composition including hydroxyl acetic acid in place of the polycarboxylic acid at identical conditions. In another broad aspect of the invention, the compositions are effective to provide enhanced removal of titanium dioxide from a surface when the composition is contacted with the surface at a temperature of less than about 50° C. relative to when the composition is contacted with an identical surface at a temperature of 80° C. Because of the relatively low effective temperatures required for use of the present compositions, many of the present compositions are suitable for clean-in-place applications.

The acid component may be any suitable polycarboxylic acid component which is effective to provide the composition with the desired acidic pH and/or which functions as described elsewhere herein. Examples of useful polycarboxylic acids include, but are not limited to 1,2,3,4-butanetetra-carboxylic acid (BTCA), citric acid, tartaric acid and maleic acid. In some embodiments, the polycarboxylic acid component is selected from the group consisting of citric acid, tartaric acid and combinations thereof.

In some embodiments of the invention, the acid component consists essentially of the polycarboxylic acid component, for example, the acid component may consist essentially of citric acid. In other embodiments, the acid component consists essentially of tartaric acid. In yet other embodiments, the acid component comprises both citric acid and tartaric acid.

The amount of acid component in the present compositions is preferably effective to provide the composition with the desired acidic pH. Thus, the amount of acid component depends on many factors, for example, on the specific polycarboxylic acid component being employed or on the pH desired for the composition. The amount of acid component preferably is in the range of about 0.5% to about 4.0% or more by weight of the composition.

The present compositions may include at least one additional component to provide a beneficial property or combination of beneficial properties which allow the present compositions and/or methods to be more effective and/or more efficient in removing titanium dioxide-containing materials from surfaces. Any suitable additional component may be employed provided that it functions as described herein and has no undue detrimental effect on the present compositions and methods and the surfaces being cleaned. Examples of such useful additional components include, but are not limited to, surfactant components, coupling components, antifoam components, odorant components, colorant components and the like. If one or more of such additional components is present, it is present in an amount effective to obtain or provide the desired property or result, that is, an effective amount of such component(s). The specific amount of each additional component included in the present compositions is not critical to the present invention and may vary depending on several factors, for example, the specific additional component being used, the specific composition being employed, and the specific property to be obtained.

In one aspect of the invention, the compositions may further comprise a chelating agent, for example, a chelating agent other than said polycarboxylic acid. In some embodiments, the chelating agent comprises tetrasodium ethylenediaminetetraacetic acid (Na₄ EDTA). In other embodiments of the invention, the chelating agent comprises a complex phosphate, preferably tetrapotassium pyrophosphate (TKPP). It is preferred that the chelating agent in the compositions of the present invention is present in the range of about 0.01% to about 10% by weight, more preferably in the range of about 1% to about 5% by weight of the aqueous composition.

The composition may further comprise an effective amount of a hydrotrope component, preferably a hydrotrope component which has an acidic nature. For example, the hydrotrope component may comprise an aromatic phosphate ester.

Preferably, the compositions of the invention further comprise an effective amount of a dispersant agent. Even more preferably the compositions comprise an effective amount of a plurality of different dispersant agents. The dispersant agent or agents may be selected from the group consisting of sodium polyacrylate solution, 2 Amino-2 Methyl-1-Propanol, sodium hexametaphosphate, and Belclene® 499, manufactured by Houghton Chemical Corporation.

The compositions preferably further comprise an effective amount of a surfactant agent. Even more preferably the compositions comprise an effective amount of a plurality of different surfactant agents. The surfactant component is effective to enhance the ability of the composition to wet the titanium dioxide-containing material on the surface. In other words, the surfactant component facilitates intimate contacting between this titanium dioxide-containing material and the present composition. Preferably, the surfactant component is nonionic and/or anionic. Examples of useful surfactant components include, and may be selected from the group consisting of, polyoxyethylene ether(5)phosphate ester, ethoxylated alcohol, propoxylated alcohol, alkoloxylated linear alcohol, poly-(oxy-1,2-ethanediyl)-alpha-undecyl-omega alcohol, sodium polyacrylate, linear alcohol alkoxylates, poly(oxyethylkene/polyoxypropylene)monohexyl ether (as well as the corresponding monooctyl ether and monodecyl ether and combinations of any two or all three of these ethers) alkyl phenol alkoxylates, such as octyl phenol ethoxylates and nonyl phenol ethoxylates, hydrocarbyl substituted sulfonic acids, such as dodecyl benzene sulfonic acid, and the like and mixtures thereof. Specific surfactants include: those sold by Huntsman under the trademarks Surfonic N-95 and Surfonic N-40; that sold by Olin under the trademark Polytergent SLF-18; those sold by Rohm and Haas Company under the trademarks Triton X-15, Triton X-35, Triton X-45, Triton X-114, Triton X-100, Triton X-102 and Triton X-165; that sold by Chemax, Inc. under the trademark Chemal LF 40B; those sold by BASF Chemical Company under the trademark Plurafac SLF 18; and those manufactured by Tomah Products under the trademark Tomadol 1-3. Preferably, the surfactant component is present in an amount in the range of about 0.1% or about 0.5% or about 5% or about 20% by weight of the composition, for example is present in an amount of about 0.8% by weight of the composition.

The present compositions may be derived from concentrates, for example, by combining water and a concentrate or concentrates. These concentrates, which may comprise relatively large concentrations of the active components described elsewhere herein, are considered to be within the scope of the present invention. Such concentrates may include an inert component or diluent, for example, water, for example, about 20% by weight of water. The specific amounts of the various components of the present compositions noted above generally refer to the amount of the active component without considering any inert component or diluent.

In accordance with the present invention, methods are provided for removing titanium dioxide from surfaces including the step of contacting the titanium dioxide-containing material located on the surface of equipment, with the aqueous compositions described herein, at conditions effective to remove such material. Although elevated temperature conditions can be employed, it is preferable to use relatively low temperatures or ambient temperatures, preferably at up to about, but not substantially greater than 50° C. during such contacting.

Effective contacting times may vary depending, for example, on the specific composition and contacting conditions being employed and on the specific removal application involved. Preferably, such contacting occurs for a time in the range of about 30 seconds or about one minute to about 1 hour to about 2 hours to about 3 hours. In addition, in some embodiments of the present invention, the composition can be used for removing titanium dioxide residue on a “once-thru”, or single pass, basis. More specifically, in these embodiments of the invention, the composition is passed into or onto the equipment to be cleaned only a single time, rather than being recirculated or recycled back through the equipment to be cleaned. Alternatively, in other embodiments of the invention, the composition, after being passed into or onto the equipment to be cleaned, is cycled back or passed back to the equipment or other equipment.

In one embodiment of the invention, the titanium dioxide-containing material on the surface is initially contacted with an aqueous rinse, for example, a rinse of pure water to particularly dissolve and to impact the titanium dioxide-containing material on the surface with sufficient force, for example, at a pressure about 30 psi or about 50 psi, to mechanically remove at least a portion of the titanium dioxide-containing material from the surface. Preferably, the aqueous rinse is at a temperature of between about 10° C. and 30° C. during this step. Alternatively, in other embodiments of the invention, an aqueous rinse is not required to remove some of the titanium dioxide.

Next, the method comprises contacting a remaining portion of the titanium dioxide-containing material located on the surface with an acidic composition at a temperature in a range of between about 20° C. and about 50° C., thereby removing at least some of, preferably substantially all of, the remaining portion from the surface.

Electric conductivity measurements of the composition and the rinse medium may be employed, for example, to maintain the “strength” of the composition used for removing the titanium dioxide-containing material, particularly when the composition is being used in a “recycle” mode, and to validate the cleanliness of the equipment after the equipment has been cleaned.

For example, the electric conductivity of the spent composition may be monitored as the composition exits the equipment to be cleaned. One can determine, at least semi-quantitatively, the “strength” of this composition, that is, the ability of the composition to remove further titanium dioxide-containing material based upon the electric or electrical conductivity of the composition. Generally, all other things being equal, the ability of the composition to remove titanium dioxide-containing material is directly proportional to, that is increases with increases in and decreases with decreases in, the electrical conductivity of the composition. By monitoring the electrical conductivity, and thus the “strength” of this composition, one can determine whether or not active material concentrate needs to be added to the composition being used. Preferably, sufficient active material concentrate is added to the recirculating composition so as to maintain the “strength” of the composition at a certain level. This electrical conductivity monitoring and composition strength controlling function is preferably accomplished by an electronic controller, such as that included in the system sold by Dober Chemical Corporation under the trademark Chematic C.I.P.

Various types of analytical equipment and instruments may be used to validate the cleanliness of a piece of equipment after treatment with the present compositions. After the treatment, preferably including rinsing, an area of the treated equipment surface is swabbed to collect any cleaning composition residue. This residue can then be dissolved in a suitable solvent and the residue-containing solvent is analyzed. The cleanliness of the piece of equipment is validated when the analysis is within acceptable limits.

After the piece of equipment has been validated as being clean, it can be returned to service, for example, in the food or pharmaceutical industry to coat products with a titanium dioxide-containing material.

In some embodiments of the present invention, a cool water pre-rinse step is not necessary for the effectiveness of the method in removing titanium dioxide residue from a surface. The necessity of a cool water pre-rinse step depends, at least in part, upon the source of the titanium dioxide coating.

The following non-limiting examples illustrate certain aspects of the present invention.

### EXAMPLE 1

A composition in accordance with the invention is made up of the following components:

| Material | Weight percent |
|---|---|
| deionized water | 71.7 |
| citric acid | 2.3 |
| tetra sodium salt of EDTA | 1.0 |
| sodium polyacrylate solution | 0.5 |
| c8–10, ethoxylated, propoxylated alcohols | 2.0 |
| alkoloxylated linear alcohol | 2.0 |
| 2 Amino-2 methyl-1-propanol | 2.5 |
| Sodium hexametaphosphate | 1.0 |
| Belclene ® 499 | 1.0 |
| Poly-oxy-1,2-ethanediyl)-alpha-undecyl-omega | 1.0 |
| Aromatic Phosphate Ester | 4.1 |
| Propylene Glycol | 10.9 |

The pH of the neat product composition is preferably between 4 and 5. At use dosage, the composition has a pH preferably between 4.5 and 4.8.

The composition is used at a temperature range of between about 25° C. to about 45° C., and no greater than about 50° C.

The plurality of surfactants in the composition or product produces a low cloud point which controls the foam of the composition. Preferably, the composition does not include or require an anti-foam agent. Further, the composition preferably does not include N-tallowalkyl trimethylene diamine (TDO) as a dispersant.

Further, an aromatic phosphate ester component is included in the composition for hydrotroping. This component further aids in pH control.

The working composition is prepared by blending together the listed components.

This working composition is then diluted with soft tap water so that the final neat composition contains 5% by volume of the working composition.

### EXAMPLE 2

A solution of a coating, used is the pharmaceutical industry to coat tablets, which contains both titanium dioxide and iron oxide in an organic matrix, is prepared. A stainless steel panel is dipped in this solution, removed from the solution and allowed to air dry. The dried panel has a coating that simulates blending tanks or other processing equipment. This coating contains both titanium dioxide and iron oxide.

This coated panel is immersed in a quantity of diluted composition of EXAMPLE 1 at 30 degrees C. for 30 minutes. The panel is removed from the composition, gently rinsed with water and allowed to dry.

A fine film of titanium dioxide remains on the panel. This film is easily removed (wiped away) by hand.

### EXAMPLE 3

EXAMPLE 2 is repeated except that following the initial wash step the coated panel is then immersed in a second solution of the test composition at 37 degrees C. for 30 minutes.

Results similar to those obtained in EXAMPLE 2 are observed except that the fine film of titanium dioxide is somewhat less noticeable. The fine film is easily wiped away by hand.

### EXAMPLE 4

EXAMPLE 3 is repeated except that the test panel is coated with a coating solution that contains titanium dioxide and not iron oxide.

Results similar to those obtained in EXAMPLE 3 are observed except that the fine film of titanium dioxide is somewhat less noticeable.

### EXAMPLE 5

The working composition is prepared and diluted as in EXAMPLE 1.

A coated panel is provided as in EXAMPLE 2.

This coated panel is immersed in a quantity of the test composition at 70° C. for 15 minutes.

The panel is removed from the test composition, gently rinsed with water and allowed to dry.

A heavy film of titanium dioxide coating is observed on the panel after this processing.

Unlike the test performed in EXAMPLE 2, however, this heavy film is not easily removed by hand and remains on the panel after vigorous wiping.

### EXAMPLE 6

As in Example 2 stainless steel panels are coated with the coating mixture containing both iron oxide and titanium dioxide. These panels were hung in a tank which has a spray device located in it. A 30 gallon quantity of the working composition is prepared as in EXAMPLE 1 and is placed in a vessel that is connected to the spray device.

The composition, after being sprayed in the tank containing the panels, is passed back to the vessel. The composition is circulated between the tank and the vessel throughout the cleaning period. In addition, the composition starts at a temperature of about 30° C. and gradually increased to a temperature of about 35° C. throughout the cleaning period.

The cleaning period is about 30 minutes. The flowrate of the composition is 17.5-18.1 gal./minutes at a pressure of 16 psi. The spray system is one which soaks or cascades down the coated surface, rather than impacting the coated surfaces with sufficient force to mechanically remove a major portion of the coating from the surface.

During the cleaning step, no evidence of foam formation is apparent.

After the cleaning step, the coated panels are visually inspected. It appears that the heavy portion of the coating is removed and only a very faint grayish haze remains on the panel.

A second cleaning process is then performed on the test panels. The solution is prepared the same as in the initial wash step. The starting temperature of this wash step however is 37° C. The temperature is increased to 45° C. throughout the cleaning step.

The cleaning step is performed at the same flowrates and pressures as the initial step. The secondary cleaning is also performed for 30 minutes. Following this step the panel is again visually examined and it appears that the faint haze has been removed.

After this cleaning period, water at 45° C. and 10 psi is gently sprayed into the tank and continuously removed from the tank, for about 3 minutes. This rinse step uses a gentle stream of the water on a once-thru basis. A second and final rinse is then performed at ambient temperature for 3 minutes. This rinse is also on a once thru basis.

After rinsing, the panels (originally coated) are visually inspected and found to be thoroughly clean. No film or residue is seen.

While this invention has been described with respect to various specific examples and embodiments, it is to be understood that the invention is not limited thereto and that it can be variously practiced within the scope of the following claims.

What is claimed is:

1. A method for removing a titanium-dioxide containing material located on a surface, the method comprising:
contacting said titanium-dioxide containing material located on said surface with a composition at a temperature of less than about 50° C., the composition comprising a polycarboxylic acid component in an amount effective to reduce adhesion between said titanium dioxide-containing material from said surface during the contacting.

2. The method of claim 1 wherein the composition has an acidic pH of less than about 4.0.

3. The method of claim 1 wherein the composition is at a temperature of less than about 40° C. during the contacting.

4. The method of claim 1 wherein the composition is at a temperature of about 30° C. during the contacting.

5. The method of claim 1 wherein the material contacted with the composition is a material containing titanium dioxide and iron-oxide.

6. The method of claim 1 wherein the step of contacting comprises directing a spray of the composition at the titanium dioxide-containing material located on the surface.

7. A method of removing a titanium-dioxide-containing and iron-oxide-containing material from a surface, the method comprising:
contacting a titanium dioxide-containing and iron-oxide-containing material on a surface with a composition comprising an acid component in an amount effective to provide the composition with an acidic pH of greater than 4.0, wherein the acid component comprises a polycarboxylic acid component in an amount effective to reduce adhesion between said titanium dioxide-containing and iron-oxide-containing material from said surface during the contacting and the composition is at a temperature of less 50° C. during the contacting.

8. A composition useful for removing a titanium dioxide-containing material located on a surface, the composition comprising:
an aqueous carrier;
an acid component in an amount effective to provide the composition with an acidic pH of greater than about 4.0, wherein the acid component comprises a polycarboxylic acid component, the composition being effective to provide enhanced removal of a titanium dioxide-containing material located on a surface when the composition is contacted with the material on the surface at a temperature of less than about 50° C. relative to when the composition is identically contacted with an identical surface at a temperature of 70° C.

9. The composition of claim 8 wherein the composition further comprises a chelating agent other than said polycarboxylic acid.

10. The composition of claim 8 wherein the acid component consists essentially of the polycarboxylic acid component.

11. The composition of claim 8 wherein the acid component comprises citric acid.

12. The composition of claim 8 wherein the acid component consists essentially of citric acid.

13. The composition of claim 8 wherein acid component comprises tartaric acid.

14. The composition of claim 8 wherein the acid component consists essentially of tartaric acid.

15. The composition of claim 8 wherein the composition further comprises an effective amount of a hydrotrope component.

16. The composition of claim 15 wherein the hydrotrope component is an aromatic phosphate ester.

17. The composition of claim 8 wherein the polycarboxylic acid component is present in the composition in an amount in a range of about 1% to about 5% by weight of the composition

18. The composition of claim 1 which further comprises a chelating agent other than citric acid.

19. The composition of claim 11 wherein the chelating agent is an ethylenediaminetetraacetic acid component.
